(19) United States
(12) Patent Application Publication
(10) Pub. No.: US 2003/0130911 A1
(43) Pub. Date: Jul. 10, 2003

(54) Method of selling firearms using a computer and a communication network

(76) Inventor: Kwok D. Wong, Novi, MI (US)

Correspondence Address: Miller, Canfield, Paddock and Stone P.L.C., c/o Robert Kelley Roth, Suite 2500, 150 West Jefferson Ave., Detroit, MI, 48226, US

(21) Appl. No.: 10/337,666

(22) Filed: Jan. 7, 2003

Related U.S. Application Data
(60) Provisional application No. 60/346,692, filed on Jan. 8, 2002.

(51) Int. Cl. G06F 17/60

(52) U.S. Cl. 705/27

(57) ABSTRACT

A method of selling a firearm using a computer and a communications network comprises the steps of listing the firearm to be sold with a facilitator, registering a bidder with the facilitator, wherein the bidder is required to specify to the facilitator a federal firearms license holder with shipping information, and having the buyer and seller agree to a price to purchase the firearm. Once the bidder and seller have agreed upon a sale price for the firearm, the facilitator sends seller information and bidder information to a federal firearms license (“FFL”) holder so that the FFL holder can properly and legally transfer the firearm to the buyer.

### RELATED APPLICATION

This application claims priority benefit of U.S. provisional patent application No. 60/346,692 filed on Jan. 8, 2002.

### FIELD OF THE INVENTION

This invention relates to a method of selling firearms, and, more particularly, to a method of selling firearms using a computer and a communication network, such as the internet.

### BACKGROUND OF THE INVENTION

With the advent of the internet, various e-commerce websites have been created to sell goods and services. Examples include www.ebay.com (“Ebay”), where sellers can list items and buyers can bid against one another for a limited period of time in a standard auction format. These sites are advantageous in that geographically remote buyers and sellers who would heretofore not be aware of one another's existence can now get together to buy and sell. Ebay however, does not sell firearms. Some other sites have been created with concentrate specifically on firearms, such as www.gunbroker.com (“Gunbroker”). Gunbroker sells firearms using the auction model of Ebay.

Gunbroker and other similar sites are limited in that they leave the details of completion of the firearm transaction to the buyer and the seller. Some firearms have to be transferred through a Federal Firearms License (“FFL”) holder, and the Gunbroker site leaves the details of identifying such an FFL holder to the parties attempting to buy and sell the firearm. This can be problematic, as many firearm owners do not know the requirements of how to legally transfer firearms inter- or intra-state. It would be desirable to provide a method of facilitating the safe and legal transfer of firearms.

### SUMMARY OF THE INVENTION

In accordance with a first aspect, a method of selling a firearm using a computer and a communications network is disclosed which comprises the steps of listing the firearm to be sold with a facilitator, registering a bidder with the facilitator, wherein the bidder is required to specify to the facilitator a federal firearms license holder with shipping information, and having the buyer and seller agree to a price to purchase the firearm. In accordance with another aspect, once the bidder and seller have agreed upon a sale price for the firearm, the facilitator sends seller information and bidder information to a federal firearms license (“FFL”) holder so that the FFL holder can properly and legally transfer the firearm to the buyer/bidder.

From the foregoing disclosure and the following more detailed description of various preferred embodiments it will be apparent to those skilled in the art that the present invention provides a significant advance in the technology and art of methods of selling firearms. Particularly significant in this regard is the potential the invention affords for providing a high quality, safe, low cost, method of selling firearms with enhanced reliability. Additional features and advantages of various preferred embodiments will be better understood in view of the detailed description provided below.

### BRIEF DESCRIPTION OF THE DRAWINGS

FIG. 1 is a schematic flow chart showing the process of registering with a facilitator to purchase firearms.

FIG. 2 is a schematic flow chart showing the process of firearms delivery.

FIG. 3 is a schematic flow chart describing the process of enrollment with the facilitator into an FFL dealer network.

It should be understood that the appended drawings are not necessarily to scale, presenting a somewhat simplified representation of various preferred features illustrative of the basic principles of the invention. The specific features of the method of selling firearms as disclosed here, including, for example, the specific operating parameters of the facilitator, will be determined in part by the particular intended application and use environment. Certain features of the illustrated embodiments have been enlarged or distorted relative to others to facilitate visualization and clear understanding.

### DETAILED DESCRIPTION OF CERTAIN PREFERRED EMBODIMENTS

It will be apparent to those skilled in the art, that is, to those who have knowledge or experience in this area of technology, that many uses and design variations are possible for the method of selling firearms disclosed here. The following detailed discussion of various alternative and preferred features and embodiments will illustrate the general principles of the invention with reference to a method of selling a firearm over the internet between remote sellers and buyers. Other embodiments suitable for other applications will be readily apparent to those skilled in the art given the benefit of this disclosure.

The method of selling a firearm 70 uses a facilitator 10. Preferably the facilitator comprises a computer program using a networked website accessible by sellers 20 and buyers/bidders 30 so that they can be linked together. As a preliminary step, viewers 40 of the website must become registered members with the facilitator 10 in order to become identified by the facilitator as sellers 20, bidders 30 or federal firearms license (hereinafter “FFL”) holders 80. FFL holders 80 are required intermediaries between buyers and sellers in the transfer of many kinds of firearms. The FFL holder performs a background check to determine that the buyer/bidder is legally permitted for the buyer to take possession/delivery of the firearm. Normally the background check is done using the National Instant Criminal Background Check System (“NICS”).

Registration requires submission of identification information. For those entities that wish to list a firearm with the facilitator 10, listing information must also be provided at some point to enable the facilitator to list the firearm on the facilitator's website. The amount and kind of information varies depending on the status of the viewer 40 that registers. That is, the seller 20 will have seller information comprising identification and listing information, including the serial number of the firearm, and the buyer 30 will submit buyer information, comprising identification and listing information, and including the FFL holder 80 and shipping information about the FFL holder. Identification information for any party can comprise, for example, a name, an address, a phone number(s), an e-mail address(es), a social security number and/or driver's license number, etc. Identification information could also comprise optional data about the user's likes and preferences. Payment information must be provided at least at the same time as bidding. Submission of payment information may occur as part of registration with the facilitator, or may, for example, be requested by the facilitator prior to any bidder making a bid. Payment information for any party can comprise, for example, a credit card number of a valid credit card account, an electronic checking service, etc.

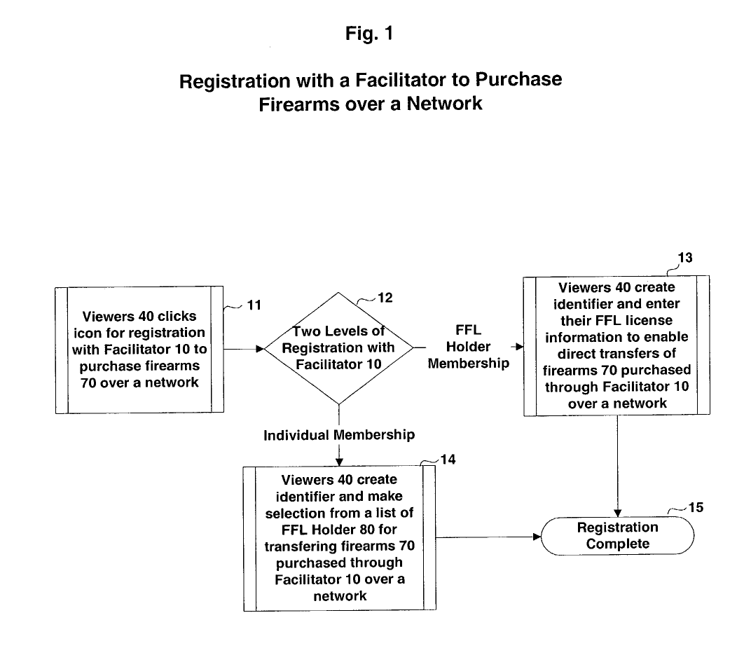

FIG. 1 shows the facilitator processing viewers 40 into either individual registered members (buyers 30 and sellers 20) or registered FFL holders 80. Preferably viewers can register without necessarily identifying themselves to the facilitator as sellers, buyers, or FFL holders 80 that wish to join the FFL dealer network (discussed in greater detail below). Such registered members can choose to become buyers and sellers at a later time. At step 11 the viewers click on a registration icon on the website. At step 12, the facilitator asks the viewers 40 to segregate themselves into individual membership and FFL holder membership. Individual membership would be created in response to submission of identification information. Individual members can later become sellers 20 who wish to list the II firearm or firearms 70 with the facilitator 10 and bidders 30 who wish to purchase the firearms. As many types of firearms require transfer only through FFL holders. Therefore, prior to completion of a transaction, the bidder 30 is required to specify to the facilitator an FFL holder 80 with shipping information of the FFL holder (step 14). The facilitator may provide a list of FFL holders for the bidder to select from. Alternatively, the facilitator can preferably allow the bidder to identify an FFL holder to transfer the firearm and/or to recommend become part of the FFL dealer network. The facilitator would then confirm that the FFL holder information provided by the bidder is accurate, and if it is, complete the transaction. As discussed in greater detail below, FFL holders may register to include themselves on the list of FFL holders that a bidder can choose from to take delivery of the firearm.

In addition to individuals, FFL holders may also identify themselves as such with the facilitator 10 upon submission and verification of their FFL license information (step 13). FFL holders 80 may be sellers and bidders of firearms 70, but individual membership sellers 20 and bidders 30 cannot be FFL holders 80. Further, in accordance with a highly advantageous feature, if the FFL holder 80 chooses to become part of the membership of the FFL dealer network, that FFL holder has the option of listing a firearm for sale only to other members of the federal firearms dealer network. Registration is complete (step 15) upon identification of registrants as individuals (bidders 30 and sellers 20) or FFL holders 80.

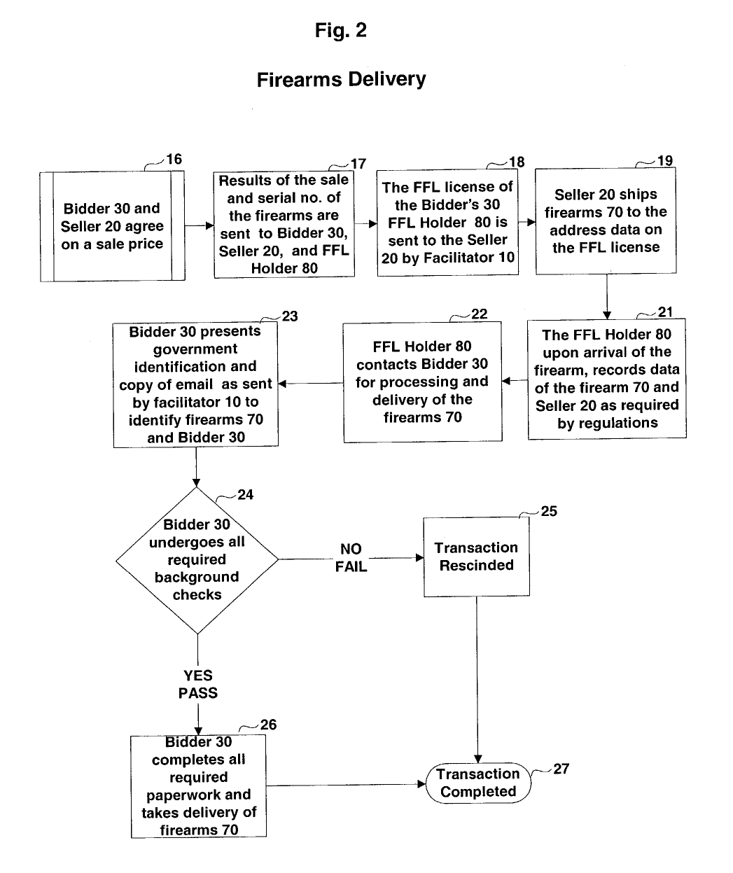

FIG. 2, shows the process of delivery of firearms from the seller 20 to the bidder 30 using the FFL holder 80 as a necessary intermediary. The bidder and the seller can agree to a price (step 16) for the sale of the firearm using any of a number of methods, such as, for example, known auction methods and the haggle method of selling items disclosed in commonly owned copending patent application Ser. No. ______. Once the buyer/bidder and seller have agreed upon a price, the facilitator 10 sends notice to the seller, bidder and the bidder's designated FFL holder 80 (step 17). The notice would have seller information comprising at least the serial number, make and model of the firearm, and buyer information comprising at least identification information about the bidder 30 and the FFL holder 80, (such as the FFL license number of the FFL holder) and shipping information such as the name and address of the FFL Holder (step 18). The notice can take the form of a confirming e-mail sent to the seller, bidder and selected FFL holder. Additionally, federal regulations require a signed paper copy of the FFL holder's license. Therefore, the facilitator would preferably be provided with signed copies (in blue or red ink) of an FFL holder's license so that when the seller and bidder agree on a purchase price, the facilitator can mail a paper copy of the license (which would include the FFL holder shipping information) and any other pertinent license data to the seller. At step 19, now that the seller has been provided with the FFL holder shipping information, the seller ships the firearm with the FFL holder's license to the address provided. At step 20, upon arrival of the firearm at the FFL holder 80, the FFL holder would record the data of the firearm, comprising, for example, it serial number and the identification information of the person (the seller) who shipped the firearm, as well as any other information required by controlling regulations. At step 22, the FFL holder would notify the bidder 30 that the firearm has arrived, and make arrangements for the bidder to take delivery.

When the bidder 30 arrives at the FFL holder 80, the bidder presents government identification (such as a driver's license, a social security number, etc.) and the e-mail sent from the facilitator 10 which identifies the firearms and the bidder. (Step 23) The FFL holder would then perform the NICS background check, along with any other procedures required by regulations or law. (Step 24). If the bidder passes the background check, the bidder can complete provide sufficient information for the FFL holder to release the firearm to the bidder. (Step 26) If the bidder does not pass the background check, the transaction is rescinded (step 25). Notice of the results of the background check and whether the bidder was able to take possession of the firearm are sent back to facilitator and the seller (step 27).

The purchase amount may be held by the facilitator in a safe keeping account until the bidder has passed the background check and is able to take possession of the firearm. Then, the facilitator can release the purchase amount (minus any appropriate handling fees and transaction fees) to the seller.

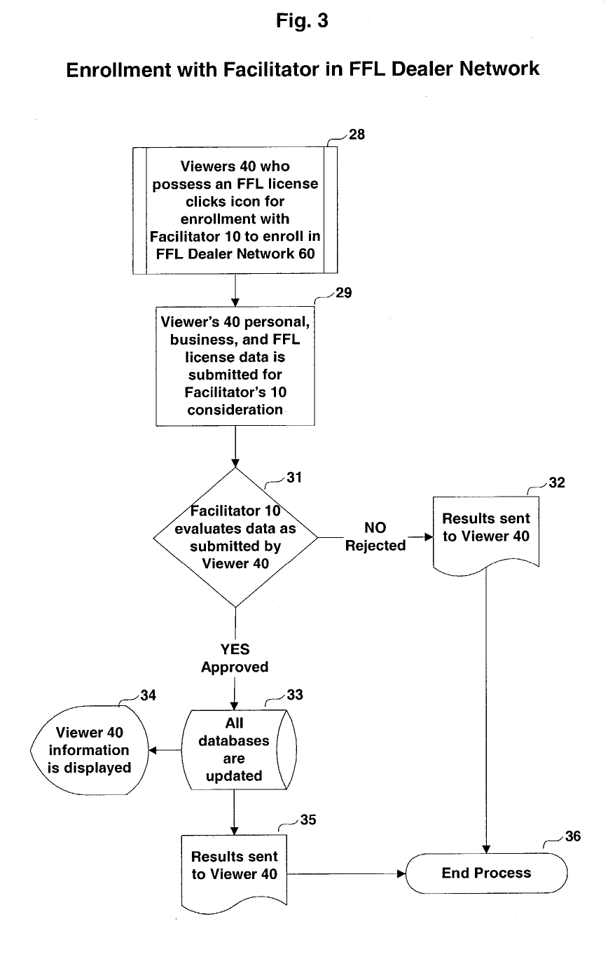

FIG. 3 shows the process where the viewer 40 who is an FFL holder 80 also has the option to enroll in the FFL dealer network. As a member of the FFL dealer network, the FFL holder can be included in the list of FFL holders which can receive the firearm 70 from the seller for transfer to the bidder (normally for a handling fee). At step 28, any viewer who is an FFL holder who wishes to be enrolled as a member of the FFL dealer network would click on an icon on the website of the facilitator. The FFL holder would then give the facilitator FFL holder license information comprising at least FFL holder license data. (step 29) The facilitator would then evaluate this FFL holder license information to confirm that it is accurate and correct. (step 31) If the information is inaccurate or incorrect, the application to enroll in the FFL dealer network is rejected and the results are sent to the viewer 40 (step 32). If the information is approved, the facilitator's databases are updated (step 33) to add a new FFL holder to the FFL dealer network. This updated network information can be displayed on the facilitator's website where it can be viewed by individuals looking for an FFL holder during registration (step 34). Once the viewer is approved as a member of the FFL dealer network (that, is an FFL holder who has chosen membership), the results can be sent to the viewer (step 35). This completes the process of FFL dealer network enrollment. (step 36).

From the foregoing disclosure and detailed description of certain preferred embodiments, it will be apparent that various modifications, additions and other alternative embodiments are possible without departing from the true scope and spirit of the invention. The embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A method of selling a firearm using a computer and a communications network comprising in combination, the steps of:
listing the firearm to be sold with a facilitator;
registering a bidder with the facilitator, wherein the bidder is required to specify to the facilitator a federal firearms license holder with shipping information; and
having the bidder and seller agree to a price to purchase the firearm.

2. The method of selling the firearm of claim 1 further comprising:
releasing to the seller the shipping information of the federal firearms license holder once the bidder and seller have agreed upon a sale price for the firearm so that the bidder can take delivery of the firearm.

3. The method of selling the firearm of claim 1 further comprising
once the bidder and seller have agreed upon the sale price for the firearm, notifying the federal firearms license holder that the firearm is going to be shipped and identifying the bidder.

4. The method of selling a firearm of claim 1 further comprising
having the facilitator provide a safe keeping account, wherein a payment of the bidder is held until the bidder is takes delivery of the firearm.

5. The method of selling the firearm of claim 1 further comprising:
providing the bidder with a list of federal firearms license holders.

6. The method of selling the firearm of claim 1 wherein the facilitator comprises a networked web site where both the seller and the bidder can register.

7. A method of selling a firearm using a computer and a communications network comprising in combination, the steps of:
registering a seller and a bidder with a facilitator, producing seller information and bidder information; and
listing the firearm to be sold with the facilitator;
wherein once the bidder and seller have agreed upon a sale price for the firearm, the facilitator sends at least part of the seller information and at least part of the bidder information to a federal firearms license holder.

8. The method of claim 7 wherein the seller information sent to the federal firearm license holder comprises a serial number of the firearm, and a make and model of firearm.

9. The method of selling the firearm of claim 7 wherein the bidder information sent to the federal firearm license holder comprises a name and address of the bidder.

10. The method of selling the firearm of claim 7 wherein the seller ships the firearm to the federal firearms licensee holder where the bidder can take delivery of the firearm, subject to a National Instant Criminal Background Check System permitting the bidder to receive the firearm.

11. The method of selling the firearm of claim 7 wherein the bidder information comprises payment information and the facilitator performs one of closing the sale of the firearm upon successful processing of the payment information of the bidder, or rejecting the sale upon unsuccessful processing of the payment information of the bidder.

12. The method of selling the firearm of claim 11 wherein the payment information comprises a credit card number of a credit card account, and the bidder information comprises a shipping address of the federal firearms license holder for the seller to ship the firearm to.

13. The method of selling the firearm of claim 7 wherein a viewer can register with the facilitator as a federal firearms license holder upon submission of federal firearms license holder information.

14. The method of selling the firearm of claim 13 further comprising
producing a federal firearms dealer network by asking each registered federal firearms license holder whether to be included as a member of the network.

15. The method of selling the firearm of claim 14 wherein facilitator can provide the bidder with the option of specifying a federal firearms license holder from the membership of the federal firearms dealer network.

16. The method of selling the firearm of claim 14 further comprising
granting a federal firearms holder the option of listing the firearm for sale only to members of the federal firearms dealer network.

17. The method of selling the firearm of claim 7 wherein the federal firearms license holder is identified by the bidder and the at least part of the bidder information comprises license data of the federal firearms license holder.
